(19) United States
(12) Patent Application Publication
(10) Pub. No.: US 2022/0127526 A1
(43) Pub. Date: Apr. 28, 2022

(54) OPTICAL FILM HAVING HIGH RELIABILITY AND METHOD FOR MANUFACTURING THE SAME

(71) Applicant: NAN YA PLASTICS CORPORATION, Taipei (TW)

(72) Inventors: TE-CHAO LIAO, TAIPEI (TW); CHUN-CHE TSAO, TAIPEI (TW); Ren-Yu Liao, New Taipei City (TW)

(21) Appl. No.: 17/384,907

(22) Filed: Jul. 26, 2021

(30) Foreign Application Priority Data
Oct. 26, 2020 (TW) 109137022

(51) Int. Cl. C09K 11/06; G02B 5/22; C08J 7/04; C08J 7/043; C08J 7/048; C09D 1/00; C09D 7/61; C09D 7/63; C09D 133/08

(52) U.S. Cl. CPC C09K 11/06; G02B 5/22; C08J 7/0423; C08J 7/043; C08J 7/048; C08J 2475/04; C09D 7/61; C09D 7/63; C09D 133/08; C09K 2211/10; C08J 2367/02; C09D 1/00

(57) ABSTRACT

An optical film having high reliability and a method for manufacturing the same are provided. The optical film includes a quantum dot layer, an upper protective layer and a lower protective layer. The upper protective layer is formed on a surface of the quantum dot layer. The lower protective layer is formed on another opposite surface of the quantum dot layer. The upper protective layer and the lower protective layer each include a bonding layer, a moisture and oxygen barrier layer, and a substrate layer located between the bonding layer and the moisture and oxygen barrier layer. The bonding layer is arranged proximate to the quantum dot layer and formed from an aqueous coating material. The moisture and oxygen barrier layer is arranged away from the quantum dot layer and includes an evaporated layer and an outer plastic layer formed on the evaporated layer.

### CROSS-REFERENCE TO RELATED PATENT APPLICATION

This application claims the benefit of priority to Taiwan Patent Application No. 109137022, filed on Oct. 26, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an optical film, and more particularly to an optical film having high reliability and a method for manufacturing the same.

### BACKGROUND OF THE DISCLOSURE

With the rapid development of audiovisual entertainment industries, the demand for displays continues to rise. Displays with both high chroma and low profile have gradually become a mainstream development trend in the market.

Under the NTSC (National Television System Committee) standard, the color gamut of an LED reaches 72%, and the color gamut of an OLED can reach up to 100%. Among luminescent materials used for displays, a quantum dot film has better color purity and a wider color gamut. The color purity of the quantum dot film is 50% higher than that of the LED, and the color gamut of the quantum dot film can reach up to 110%. The quantum dot film has gradually received attention due to good optical display characteristics, and has become one of preferred materials used under the current trend of providing excellent viewing experiences.

However, quantum dot film displays are not popular in the current market, mainly because a quantum dot film is not resistant to water and oxygen. Once a peripheral edge area of the quantum dot film comes into contact with exterior air or moisture, an edge degradation problem would occur in the peripheral edge area, which does not meet the basic requirements for long-term stable use of the displays.

A common water-proof and oxygen-proof treatment method is to attach two barrier films to upper and lower sides of the quantum dot film, respectively, which can prevent the quantum dot film from being penetrated by water and oxygen and thus lose its luminous characteristics. Although the two barrier films can increase product stability, thereby extending service life, the two barrier films have high production costs, contribute to a greater thickness, and their adhesion to the quantum dot film is less than satisfactory. In consideration of market price, product quality, and economic benefits, the products of the quantum dot film displays have been unable to achieve breakthroughs in development and widespread promotion.

Therefore, how the requirements of long-term water and oxygen resistances can be met, while providing a balance between the thickness of the barrier layer and the production costs, are important issues for future promotion of the quantum dot film displays.

### SUMMARY OF THE DISCLOSURE

In response to the above-referenced technical inadequacies, the present disclosure provides an optical film having high reliability that can not only prevent failure of quantum dots, but also increase structural stability. The present disclosure also provides a method for manufacturing the optical film.

In one aspect, the present disclosure provides an optical film having high reliability, which includes a quantum dot layer, an upper protective layer, and a lower protective layer. The quantum dot layer has a first surface and a second surface opposite to the first surface. The upper protective layer is formed on the first surface and the lower protective layer is formed on the second surface. The upper protective layer and the lower protective layer each include a bonding layer, a moisture and oxygen barrier layer, and a substrate layer located between the bonding layer and the moisture and oxygen barrier layer. The bonding layer is arranged proximate to the quantum dot layer and formed from an aqueous coating material. The moisture and oxygen barrier layer is arranged away from the quantum dot layer and includes an evaporated layer and an outer plastic layer formed on the evaporated layer.

In another aspect, the present disclosure provides a method for manufacturing an optical film having high reliability, which includes: providing a substrate layer; forming a moisture and oxygen barrier layer on an outer surface of the substrate layer, and coating an aqueous coating material on an inner surface of the substrate layer; the moisture and oxygen barrier layer includes an evaporated layer and an outer plastic layer formed on the evaporated layer; and attaching the substrate layer with the moisture and oxygen barrier layer to a quantum dot layer by the aqueous coating material and curing the aqueous coating material into a bonding layer; the bonding layer, the substrate layer, and the moisture and oxygen barrier layer jointly form a protective layer.

In one embodiment of the present disclosure, the evaporated layer is an evaporated layer of aluminum oxide or copper.

In one embodiment of the present disclosure, the outer plastic layer is a polyurethane (PU) layer.

In one embodiment of the present disclosure, the evaporated layer has a thickness from 0.01 μm to 0.5 μm, and the outer plastic layer has a thickness from 0.5 μm to 10 μm.

In one embodiment of the present disclosure, the substrate layer is a polyethylene terephthalate (PET) layer.

In one embodiment of the present disclosure, the aqueous coating material includes 5 to 15 wt % of isopropanol, 5 to 15 wt % of sodium bicarbonate, 5 to 20 wt % of an organic acid, and 10 to 30 wt % of at least one acrylic-based monomer.

In one embodiment of the present disclosure, the at least one acrylic-based monomer is selected from a group consisting of tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

One of the beneficial effects of the present disclosure is that, the optical film having high reliability can allow quantum dots to be completely isolated from the external environment, thereby preventing the quantum dots from failure due to coming in contact with moisture or oxygen, and can improve adhesion between layers, by virtue of “the upper protective layer and the lower protective layer each including a bonding layer proximate to the quantum dot layer and a moisture and oxygen barrier layer distant from the quantum dot layer, in which the bonding layer is formed from an aqueous coating material and the moisture and oxygen barrier layer includes an evaporated layer and an outer plastic layer formed on the evaporated layer”.

Furthermore, the optical film of the present disclosure does not need one or more additional adhesive layers, and a total thickness and production costs are therefore reduced.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a structural schematic view of an optical film having high reliability of the present disclosure;

FIG. 2 is an enlarged view of part II of FIG. 1;

FIG. 3 is an enlarged view of part III of FIG. 1; and

FIG. 4 is a flowchart of a method for manufacturing the optical film having high reliability of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way.

Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

Unless defined otherwise, all technical and scientific terms used herein have the same meanings as commonly understood by one of ordinary skill in the art to which this invention belongs. As used herein, the singular forms “a,” “an,” and “the,” are intended to include the plural forms.

Unless indicated otherwise, all percentages disclosed herein are in weight percent. The upper and lower limits of these smaller ranges may independently be included in the smaller ranges and are also encompassed within the disclosure, subject to any specifically excluded limit in the stated range.

### First Embodiment

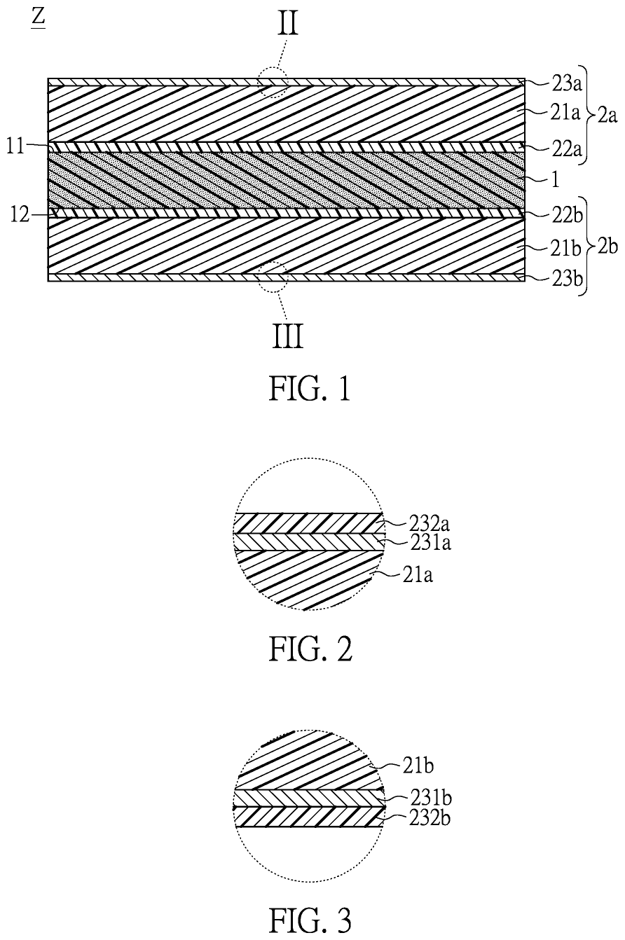

Referring to FIG. 1, a first embodiment of the present disclosure provides an optical film Z having high reliability, which includes a quantum dot layer 1, an upper protective layer 2a, and a lower protective layer 2b. The quantum dot layer 1 has a first surface 11 (e.g., an upper surface) and a second surface 12 (e.g., a lower surface) opposite to the first surface. The upper protective layer 2a is formed on the first surface 11 of the quantum dot layer 1. The lower protective layer 2b is formed on the second surface 12 of the quantum dot layer 1. In use, the upper protective layer 2a and the lower protective layer 2b can not only protect the quantum dot layer 1 from being physically damaged, but also prevent the quantum dot layer 1 from failure.

Reference is made to FIG. 2 and FIG. 3, the upper protective layer 2a and the lower protective layer 2b have the same structure. The upper protective layer 2a includes a bonding layer 22a, a moisture and oxygen barrier layer 23a, and a substrate layer 21a located between the bonding layer 22a and the moisture and oxygen barrier layer 23a. The lower protective layer 2b also includes a bonding layer 22b, a moisture and oxygen barrier layer 23b, and a substrate layer 21b located between the bonding layer 22b and the moisture and oxygen barrier layer 23b. It should be noted that, the bonding layer 22a of the upper protective layer 2a and the bonding layer 22b of the lower protective layer 2b are arranged proximate to the quantum dot layer 1 and are each formed from an aqueous coating material. The aqueous coating material can use the same polymer system (e.g., an acrylic system) as the quantum dot layer 1, so as to increase adhesion of layers. The moisture and oxygen barrier layer 23a of the upper protective layer 2a and the moisture and oxygen barrier layer 23b of the lower protective layer 2b are arranged away from the quantum dot layer 1, and each include an evaporated layer 231a, 231b and an outer plastic layer 232a, 232b formed on the evaporated layer 231a, 231b. Therefore, quantum dots can be completely isolated from the external environment to effectively block moisture and oxygen.

In practice, the substrate layer 21a of the upper protective layer 2a and the substrate layer 21b of the lower protective layer 2b are each formed from a polyester, so as to have characteristics including high transparency and high stiffness. Specific examples of the polyester include polyethylene terephthalate (PET), polypropylene terephthalate (PPT), polybutylene terephthalate (PBT), polyethylene naphthalate (PEN), polybutylene naphthalate (PBN), polycyclohexylenedimethylene terephthalate (PCT), polycarbonate (PC), and polyarylate. The polyester is preferably PET. Furthermore, the substrate layer 21a of the upper protective layer 2a and the substrate layer 21b of the lower protective layer 2b can have good softness and ductility by a biaxial stretching treatment, thereby increasing a flexibility of use of the optical film Z.

The biaxial stretching treatment can be applied by a tenter-type stretching machine, but is not limited thereto. In the biaxial stretching treatment, an unstretched substrate layer 21a or substrate layer 21b is stretched in a machine direction (MD) (also called “length direction”) at a predetermined temperature and a desired stretch ratio, and is then stretched in a transverse direction (TD) (also called “width direction”) at another predetermined temperature and the desired stretch ratio, so as to form a biaxially stretched substrate layer 21a or substrate layer 21b. According to practical requirements, a stretching process of the machine direction and a stretching process of the transverse direction can be applied in the reverse order. Also, in the biaxial stretching treatment, the unstretched substrate layer 21a or substrate layer 21b can be simultaneously and biaxially stretched in the machine direction and transverse direction at still another predetermined temperature and the desired stretch ratio.

The aqueous coating material for forming the bonding layer 22a of the upper protective layer 2a and the bonding layer 22b of the lower protective layer 2b includes isopropanol (IPA), sodium bicarbonate, an organic acid, and at least one acrylic-based monomer. The aqueous coating material can be coated on an inner surface of the substrate layer 21a and then be cured (e.g., cured with heat or light) to form the bonding layer 22a. Based on the consideration of costs and adhesion of layers, a thickness of the bonding layer 22a can be from 0.01 μm to 0.5 μm. Similarly, the aqueous coating material can be coated on an inner surface of the substrate layer 21b and then be cured (e.g., cured with heat or light) to form the bonding layer 22b. Based on the same consideration, a thickness of the bonding layer 22b can be from 0.01 μm to 0.5 μm.

More specifically, a pH value of the aqueous coating material can be between 5.0 and 6.7. Based on 100 weight percent (wt %) of the aqueous coating material, a content of water can be from 30 wt % to 70 wt %, a content of the IPA can be from 5 wt % to 15 wt %, a content of the sodium bicarbonate can be from 5 wt % to 15 wt %, a content of the organic acid can be from 5 wt % to 20 wt %, and a content of the at least one acrylic-based monomer can be from 10 wt % to 30 wt %.

Examples of the acrylic-based monomer of the aqueous coating material include: tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

In the moisture and oxygen barrier layer 23a of the upper protective layer 2a, the evaporated layer 231a can be an evaporated layer of aluminum oxide or copper, and the outer plastic layer 232a can be a polyurethane (PU) layer formed by coating. Based on the consideration of costs and product reliability, a thickness of the evaporated layer 231a can be from 0.01 μm to 0.5 μm, and a thickness of the outer plastic layer 232a can be from 0.5 μm to 10 μm. Similarly, in the moisture and oxygen barrier layer 23b of the lower protective layer 2b, the evaporated layer 231b can be an evaporated layer of aluminum oxide or copper, and the outer plastic layer 232b can be a polyurethane (PU) layer formed by coating. Based on the same consideration, a thickness of the evaporated layer 231b can be from 0.01 μm to 0.5 μm, and a thickness of the outer plastic layer 232b can be from 0.5 μm to 10 μm.

In certain embodiments, the thickness of the evaporated layer 231a (the evaporated layer 231b) can be 0.05 μm, 0.1 μm, 0.15 μm, 0.2 μm, 0.25 μm, 0.3 μm, 0.35 μm, 0.4 μm or 0.45 μm. The thickness of the outer plastic layer 232a (the outer plastic layer 232b) can be 1 μm, 1.5 μm, 2 μm, 2.5 μm, 3 μm, 3.5 μm, 4 μm, 4.5 μm, 5 μm, 5.5 μm, 6 μm, 6.5 μm, 7 μm, 7.5 μm, 8 μm, 8.5 μm, 9 μm or 9.5 μm.

The quantum dot layer 1 mainly includes quantum dots, and in addition, can include a photoinitiator, a plurality of scattering particles, a mercaptan, and at least one acrylic-based monomer. Based on a total weight of the quantum dot layer 1 being 100 wt %, a content of the quantum dots can be from 0.1 wt % to 10 wt %, a content of the photoinitiator can be from 1 wt % to 5 wt %, a content of the scattering particles can be from 1 wt % to 30 wt %, a content of the mercaptan can be from 15 wt % to 65 wt %, and a content of the at least one acrylic-based monomer can be from 30 wt % to 60 wt %.

Examples of the photoinitiator of the quantum dot layer 1 include: 1-hydroxycyclohexyl phenyl ketone, benzoyl isopropanol, tribromomethyl phenyl sulfone, and diphenyl(2,4,6-trimethylbenzoyl) phosphine oxide.

The scattering particles of the quantum dot layer 1 can be surface treated microbeads having a diameter of 0.5 μm to 20 μm that are made of acrylic, silicon dioxide, or polystyrene.

Examples of the mercaptan of the quantum dot layer 1 include: 2,2′-(ethylenedioxy) diethanethiol, 2,2′-thiodiethanethiol, trimethylolpropane tris(3-mercaptopropionate), poly(ethylene glycol) dithiol, pentaerythritol tetrakis (3-mercaptopropionate), ethylene glycol bis-mercaptoacetate, and ethyl 2-mercaptopropionate.

Examples of the acrylic-based monomer of the quantum dot layer 1 include: tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

Table 1 below shows performances of various target parameters of quantum dot layers 1 resulting from different ratios of mercaptan to acrylic. It can be seen from Table 1 that a preferable ratio of mercaptan to acrylic is 3:7, 5:5, or 6:4.

TABLE 1

| | | UV | Physical | | | |
|---|---|---|---|---|---|---|
| Mercaptan | Acrylic | intensity | properties | Environmental | Optical | |
| (wt %) | (wt %) | (mJ/cm²) | of film | testing | properties | Adhesion |
| 15 | 70 | 1200 | Too soft | Fail | Fair | Fair |
| 35 | 50 | 700 | Preferable | Pass | Preferable | Preferable |
| 55 | 30 | 500 | Too hard | Pass | Preferable | Preferable |
| 65 | 20 | 1000 | Too hard | Fail | Fair | Preferable |

In Table 1, the target parameters are tested by methods as follows:

UV intensity: tested by a UV intensity sensor (UV Power Puck® II available from EIT Inc, USA).

Adhesion: tested through pulling apart upper and lower protective layers from a quantum dot layer by a tensile machine, the quantum dot layer being clamped between the upper and lower protective layers prior to the test. If the upper and lower protective layers are broken after being pulled apart from the quantum dot layer (i.e., the upper and lower protective layers cannot be pulled apart without breaking), an adhesion of the quantum dot layer is recorded as “good”. If each of the upper and lower protective layers has a gel layer adhered thereon after being pulled apart from the quantum dot layer, an adhesion of the quantum dot layer is recorded as “fair”. If only one of the upper and lower protective layers has a gel layer adhered thereon after being pulled apart from the quantum dot layer, an adhesion of the quantum dot layer is recorded as “poor”.

Physical properties: tested by a bending machine with a bending angle of 60 degrees and observed whether brittle fracture or permanent deformation occurs in the quantum dot layer after being bent for 10,000 times.

Optical properties: tested by a luminance meter with an irradiation of a backlight module, in which conditions for excitation include a 12 W blue light source, a color coordinate of (x=0.155, y=0.026), a dominant wavelength of 450 nm, and a full width at half maximum of 20 nm.

Environmental testing: tested in an environmental testing box under conditions of a temperature of 65° C. and a relative humidity of 95%, after which a difference of color coordinate is less than 0.01 and a decline rate of brightness is less than 15%. The quantum dot layers are taken out of the environmental testing box every 250 hours for testing adhesion, physical properties, and optical properties.

### Second Embodiment

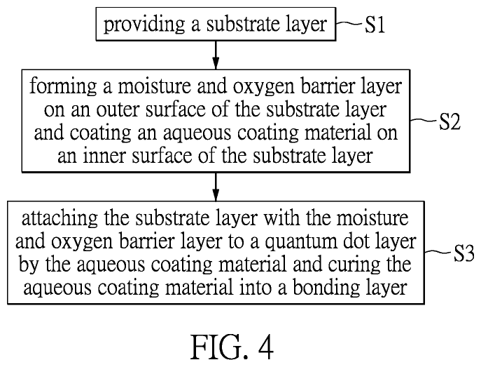

Reference is made to FIG. 4, which is to be read in conjunction with FIG. 1. The present disclosure further provides a method for manufacturing an optical film Z having the above-mentioned structure, which includes: step S1, providing a substrate layer; step S2, forming a moisture and oxygen barrier layer on an outer surface of the substrate layer and coating an aqueous coating material on an inner surface of the substrate layer; and step S3, attaching the substrate layer with the moisture and oxygen barrier layer to a quantum dot layer by the aqueous coating material and curing the aqueous coating material into a bonding layer. Although this embodiment merely describes forming a protective layer on one side of the quantum dot layer, in practice, the method of the present disclosure can form two protective layers on two sides of the quantum dot layer, respectively. Accordingly, quantum dots can be completely isolated from the external environment, thereby preventing the quantum dots from failure due to coming in contact with moisture or oxygen.

In step S1, the substrate layer can be formed from a polyester. Specific examples of the polyester include polyethylene terephthalate (PET), polypropylene terephthalate (PPT), polybutylene terephthalate (PBT), polyethylene naphthalate (PEN), polybutylene naphthalate (PBN), polycyclohexylenedimethylene terephthalate (PCT), polycarbonate (PC), and polyarylate. The polyester is preferably PET. Furthermore, the substrate layer 21 can be biaxially stretched.

In step S2, an evaporated layer can be formed on the outer surface of the substrate layer by evaporating, and an outer plastic layer can then be formed on the evaporated layer by coating, so as to form the moisture and oxygen barrier layer. In addition, the aqueous coating material coated on the inner surface of the substrate layer mainly includes isopropanol (IPA), sodium bicarbonate, an organic acid and at least one acrylic-based monomer. Based on 100 weight percent (wt %) of the aqueous coating material, a content of water can be from 30 wt % to 70 wt %, a content of the IPA can be from 5 wt % to 15 wt %, a content of the sodium bicarbonate can be from 5 wt % to 15 wt %, a content of the organic acid can be from 5 wt % to 20 wt %, and a content of the at least one acrylic-based monomer can be from 10 wt % to 30 wt %.

Examples of the acrylic-based monomer of the quantum dot layer 1 include: tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

In step S3, the substrate layer with the moisture and oxygen barrier layer is attached to a surface of the substrate layer by being spaced apart from the aqueous coating material, and the aqueous coating material is then cured into a bonding layer. The bonding layer, the substrate, and the moisture and oxygen barrier layer jointly form a protective layer. The quantum dot layer mainly includes quantum dots, and can further include a photoinitiator, a plurality of scattering particles, a mercaptan, and at least one acrylic-based monomer. Based on a total weight of the quantum dot layer 1 being 100 wt %, a content of the quantum dots can be from 0.1 wt % to 10 wt %, a content of the photoinitiator can be from 1 wt % to 5 wt %, a content of the scattering particles can be from 1 wt % to 30 wt %, a content of the mercaptan can be from 15 wt % to 65 wt %, and a content of the at least one acrylic-based monomer can be from 30 wt % to 60 wt %.

Examples of the photoinitiator of the quantum dot layer 1 include: 1-hydroxycyclohexyl phenyl ketone, benzoyl isopropanol, tribromomethyl phenyl sulfone, and diphenyl(2,4,6-trimethylbenzoyl) phosphine oxide.

The scattering particles of the quantum dot layer 1 can be surface treated microbeads having a diameter of 0.5 μm to 20 μm that are made of acrylic, silicon dioxide, or polystyrene.

Examples of the mercaptan of the quantum dot layer 1 include: 2,2′-(ethylenedioxy) diethanethiol, 2,2′-thiodiethanethiol, trimethylolpropane tris(3-mercaptopropionate), poly(ethylene glycol) dithiol, pentaerythritol tetrakis (3-mercaptopropionate), ethylene glycol bis-mercaptoacetate, and ethyl 2-mercaptopropionate.

Examples of the acrylic-based monomer of the quantum dot layer 1 include: tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

The method of the present disclosure can further include: step S4, cutting the optical film to a required size; and step S5, winding the remaining optical film into a roll for use or storage in a convenient manner.

### BENEFICIAL EFFECTS OF THE EMBODIMENTS

One of the beneficial effects of the present disclosure is that, the optical film having high reliability can allow quantum dots to be completely isolated from the external environment, thereby preventing the quantum dots from failure due to coming in contact with moisture or oxygen, and can improve adhesion between layers, by virtue of “the upper protective layer and the lower protective layer each including a bonding layer proximate to the quantum dot layer and a moisture and oxygen barrier layer away from the quantum dot layer, in which the bonding layer is formed from an aqueous coating material and the moisture and oxygen barrier layer includes an evaporated layer and an outer plastic layer formed on the evaporated layer”.

The above beneficial effect(s) can be verified from performance test results shown in Table 2.

TABLE 2

| Moisture and oxygen | | |
|---|---|---|
| barrier layer | Inclusive | Non-inclusive |
| Difference of color | Δx 0.0011 | Δx 0.0058 |
| coordinate through | Δy 0.0005 | Δy 0.0121 |
| environmental testing | 3% decline rate of | 12% decline rate of |
| under high temperature | brightness | brightness |
| and high humidity | | |
| conditions (65° C. and | | |
| 95% relative humidity, | | |
| 1000 hours) | | |
| Difference of color | Δx 0.0031 | Δx 0.0068 |
| coordinate through | Δy 0.0045 | Δy 0.0151 |
| environmental testing | 15% decline rate of | 16% decline rate of |
| under high temperature | brightness | brightness |
| condition (85° C., 1000 | | |
| hours) | | |

Furthermore, the optical film of the present disclosure does not need one or more additional adhesive layers, and a total thickness and production costs are therefore reduced.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An optical film having high reliability, comprising:
a quantum dot layer having a first surface and a second surface opposite to the first surface;
an upper protective layer formed on the first surface; and
a lower protective layer formed on the second surface;
wherein the upper protective layer and the lower protective layer each include a bonding layer, a moisture and oxygen barrier layer, and a substrate layer located between the bonding layer and the moisture and oxygen barrier layer, the bonding layer is arranged proximate to the quantum dot layer and formed from an aqueous coating material, and the moisture and oxygen barrier layer is arranged away from the quantum dot layer and includes an evaporated layer and an outer plastic layer formed on the evaporated layer.

2. The optical film according to claim 1, wherein the evaporated layer is an evaporated layer of aluminum oxide or copper.

3. The optical film according to claim 2, wherein the outer plastic layer is a polyurethane (PU) layer.

4. The optical film according to claim 3, wherein the evaporated layer has a thickness from 0.01 μm to 0.5 μm, and the outer plastic layer has a thickness from 0.5 μm to 10 μm.

5. The optical film according to claim 1, wherein the substrate layer is a polyethylene terephthalate (PET) layer.

6. The optical film according to claim 1, wherein the aqueous coating material includes:
5 to 15 wt % of isopropanol;
5 to 15 wt % of sodium bicarbonate;
5 to 20 wt % of an organic acid; and
10 to 30 wt % of at least one acrylic-based monomer.

7. The optical film according to claim 6, wherein the at least one acrylic-based monomer is selected from a group consisting of tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.

8. A method for manufacturing an optical film having high reliability, comprising:
providing a substrate layer;
forming a moisture and oxygen barrier layer on an outer surface of the substrate layer and coating an aqueous coating material on an inner surface of the substrate layer, wherein the moisture and oxygen barrier layer includes an evaporated layer and an outer plastic layer formed on the evaporated layer; and
attaching the substrate layer with the moisture and oxygen barrier layer to a quantum dot layer by the aqueous coating material and curing the aqueous coating material into a bonding layer, wherein the bonding layer, the substrate layer, and the moisture and oxygen barrier layer jointly form a protective layer.

9. The method according to claim 8, wherein the evaporated layer is an aluminum oxide evaporated layer or a copper evaporated layer.

10. The method according to claim 9, wherein the outer plastic layer is a polyurethane (PU) layer.

11. The method according to claim 10, wherein the evaporated layer has a thickness from 0.01 μm to 0.5 μm, and the outer plastic layer has a thickness from 0.5 μm to 10 μm.

12. The method according to claim 8, wherein the substrate layer is a polyethylene terephthalate (PET) layer.

13. The method according to claim 8, wherein the aqueous coating material includes:
5 to 15 wt % of isopropanol;
5 to 15 wt % of sodium bicarbonate;
5 to 20 wt % of an organic acid; and
10 to 30 wt % of at least one acrylic-based monomer.

14. The method according to claim 13, wherein the at least one acrylic-based monomer is selected from a group consisting of tetrahydrofurfuryl methacrylate, stearyl acrylate, lauryl methacrylate, lauryl acrylate, isobornyl methacrylate, tridecyl acrylate, alkoxylated nonylphenol acrylate, tetraethylene glycol dimethacrylate, polyethylene glycol (600) dimethacrylate, tripropylene glycol diacrylate, ethoxylated (10) bisphenol A dimethacrylate, trimethylolpropane triacrylate, trimethylolpropane trimethacrylate, ethoxylated (20) trimethylolpropane triacrylate, and pentaerythritol triacrylate.
